(19) United States
(12) Patent Application Publication
(10) Pub. No.: US 2026/0140835 A1
(43) Pub. Date: May 21, 2026

(54) STORAGE SYSTEM AND CONTROL METHOD OF STORAGE SYSTEM

(71) Applicant: Hitachi Vantara, Ltd., Yokohama-shi (JP)

(72) Inventors: Yoshinori OHIRA, Tokyo (JP); Toshiyuki ARITSUKA, Tokyo (JP); Takahiro YAMAMOTO, Tokyo (JP); Taisuke ONO, Tokyo (JP)

(21) Appl. No.: 19/323,592

(22) Filed: Sep. 9, 2025

(30) Foreign Application Priority Data
Nov. 18, 2024 (JP) 2024-200997

(51) Int. Cl. G06F 11/20; G06F 11/10

(52) U.S. Cl. CPC G06F 11/2025; G06F 11/1092; G06F 11/2069

(57) ABSTRACT

A storage system provides balance to the performance of a distributed rebuild system and to the performance of a read local system in SDS. A storage controller in an active state and a storage controller in a standby state that takes over a process of the storage controller in the active state through failover are provided. The storage controllers are arranged in different nodes, form a redundancy group in which redundant data is distributed and stored. The storage system stores, in a storage device of the same node, user data input and output by the storage controller in the active state and stores redundant data of the user data in storage devices of a plurality of nodes different from the user data. The storage controller in the standby state changes to the active state and uses the redundant data to input and output data in the failover.

### CROSS-REFERENCE TO RELATED APPLICATION

The present application claims priority from Japanese application JP 2024-200997, filed on Nov. 18, 2024, the content of which is hereby incorporated by reference into this application.

### BACKGROUND OF THE INVENTION

### 1. Field of the Invention

The present invention relates to a storage system and a control method of the storage system.

### 2. Description of the Related Art

A redundancy configuration is adopted in a storage system to improve the availability and the reliability. For example, in a distributed Software-defined Storage (SDS) including a plurality of servers (nodes), it is important how to balance the recovery of data regarding the redundancy configuration and the performance of input/output (I/O) across the plurality of nodes.

An example of a system for efficiently recovering the data in the SDS includes a distributed rebuild system in which read/write of data related to the recovery of data is distributed across all nodes. An example of a system for efficient I/O in the SDS includes a read local system for reading all pieces of data from the drive of the node that has received the I/O.

For example, a technique for balancing the performance of the distributed rebuild system and the performance of the read local system in erasure coding is disclosed in PCT Patent Publication No. WO2017/145223, in which, when stripe data is lost due to a node failure, the stripe is arranged and regenerated after the failed node is removed.

However, to enable the read local again when the node is recovered after the distributed rebuild is carried out, the data needs to be written back to the recovered node through the host server in the conventional technique. Hence, it takes time to restore the read local system, and there is still room for improving the balance between the performance of the distributed rebuild system and the performance of the read local system.

The present invention has been made in view of the problem described above, and an object of the present invention is to further balance the performance of the distributed rebuild system and the performance of the read local system in SDS.

### SUMMARY OF THE INVENTION

To attain the object, an aspect of the present invention provides a storage system including a plurality of nodes each including a storage device that physically stores data and a storage controller, in which the storage controller in an active state uses a storage area of the storage device to form a virtual volume, provides the virtual volume to a host, and processes data input and output to and from the storage device through the virtual volume that the storage controller is responsible for, the storage controller in the active state and the storage controller in a standby state that takes over a process of the storage controller in the active state through failover, the storage controllers being arranged in different nodes, form a redundancy group, user data input and output by the storage controller in the active state is stored in the storage device of the same node, redundant data of the user data is stored in the storage device of the node different from the user data, the storage controller in the standby state changes to the active state and uses the redundant data to input and output data when the failover is performed, and the redundant data regarding the redundancy group is distributed and stored in a plurality of nodes.

According to the present invention, the performance of the distributed rebuild system and the performance of the read local system can be further balanced in, for example, SDS.

### BRIEF DESCRIPTION OF THE DRAWINGS

FIG. 1 depicts a configuration of an on-premises storage system according to a first embodiment;

FIG. 2 depicts a logical configuration of storage servers according to the first embodiment;

FIG. 3 depicts a logical configuration when a failure occurs in the storage server according to the first embodiment;

FIG. 4 depicts a chunk configuration of the storage system according to the first embodiment;

FIG. 5 depicts a correspondence between a volume and a chunk of the storage system according to the first embodiment;

FIG. 6 depicts a configuration of a memory of the storage server according to the first embodiment;

FIG. 7 depicts a configuration of a chunk management table according to the first embodiment;

FIG. 8 depicts a configuration of a chunk mapping table according to the first embodiment;

FIG. 9 depicts a configuration of a volume management table according to the first embodiment;

FIG. 10 depicts a configuration of a data mapping table according to the first embodiment;

FIG. 11 is a flow chart illustrating a chunk group creation process according to the first embodiment;

FIG. 12 is a flow chart illustrating a volume creation process according to the first embodiment;

FIG. 13 is a timing chart illustrating a series of processes executed from occurrence of node failure to recovery of node failure, in the storage system according to the first embodiment;

FIG. 14A depicts outlines of a normal read process, a read process after failover, a rebuild process, and a relocation process executed in the storage system according to the first embodiment;

FIG. 14B depicts outlines of a failback process and a read process after failback executed in the storage system according to the first embodiment;

FIG. 15 is a flow chart illustrating the read process according to the first embodiment;

FIG. 16 is a flow chart illustrating a write process according to the first embodiment;

FIG. 17 is a flow chart illustrating a failover process according to the first embodiment;

FIG. 18 is a flow chart illustrating the rebuild process according to the first embodiment;

FIG. 19 is a flow chart illustrating the relocation process according to the first embodiment;

FIG. 20 is a flow chart illustrating the failback process according to the first embodiment;

FIG. 21 depicts a chunk configuration of a storage system according to a second embodiment;

FIG. 22 depicts a configuration of a chunk management table according to the second embodiment;

FIG. 23 depicts a configuration of a chunk mapping table according to the second embodiment;

FIG. 24A depicts outlines of a normal read process, a read process after failover, a rebuild process, and a relocation process executed in the storage system according to the second embodiment;

FIG. 24B depicts outlines of a failback process and a read process after failback executed in the storage system according to the second embodiment; and

FIG. 25 depicts a configuration of a storage system according to a third embodiment.

### DESCRIPTION OF THE PREFERRED EMBODIMENTS

In the following description, an “interface apparatus” may be one or more communication interface devices. The one or more communication interface devices may be the same type of communication interface devices (for example, one or more Network Interface Cards (NICs)) or may be two or more types of communication interface devices (for example, an NIC and a Host Bus Adapter (HBA)).

In the following description, a “memory” is one or more memory devices that are examples of one or more storage devices, and a typical example of the “memory” includes a main storage device. At least one memory device in the memory may be a volatile memory device or may be a non-volatile memory device.

In the following description, a “drive” is a persistent storage device. A typical example of the persistent storage device includes a non-volatile storage device (for example, an auxiliary storage device), and specific examples of the persistent storage device include a Hard Disk Drive (HDD), a Solid State Drive (SSD), and a Non-Volatile Memory Express (NVMe) drive.

In the following description, a “processor” may be one or more processor devices. Although a typical example of the at least one processor device is a microprocessor device such as a Central Processing Unit (CPU), the at least one processor device may be another type of processor device such as a Graphics Processing Unit (GPU). The at least one processor device may be single-core or may be multi-core. The at least one processor device may be a processor core. The at least one processor device may be a processor device in a broad sense, such as a hardware circuit (for example, a Field-Programmable Gate Array (FPGA), a Complex Programmable Logic Device (CPLD), and an Application Specific Integrated Circuit (ASIC)) that executes part or all of processing.

In the following description, a “program” may be the subject in describing processing. The program is executed by the processor, and executes predetermined processing while appropriately using a storage apparatus and/or an interface apparatus. Hence, the subject of the processing may be the processor (or a device, such as a controller including the processor). The program may be installed on an apparatus, such as a computer, from a program source. The program source may be, for example, a program distribution server or a computer-readable (for example, non-transitory) recording medium. In the following description, two or more programs may be realized as one program, or one program may be realized as two or more programs.

In the following description, information that can obtain an output from an input may be expressed as an “xxx table.” However, the information may be data with any structure (for example, may be structured data or may be unstructured data) or may be a learning model represented by neural network, genetic algorithm, and random forest for generating an output from an input. Hence, the “xxx table” can be referred to as “xxx information.” In the following description, the configuration of each table is an example. One table may be divided into two or more tables, or all or some of two or more tables may be one table.

In the following description, a “program” may be the subject in describing processing. However, the program is executed by the processor, and executes predetermined processing while appropriately using a storage apparatus and/or an interface apparatus. Hence, the subject of the processing may be the processor (or a device, such as a controller including the processor). The program may be installed on an apparatus, such as a computer, from a program source. The program source may be, for example, a program distribution server or a computer-readable (for example, non-transitory) recording medium. In the following description, two or more programs may be realized as one program, or one program may be realized as two or more programs.

In the following description, differences from already mentioned embodiments will mainly be described in subsequent embodiments, and the description of parts overlapping the already mentioned embodiments will not be repeated.

### First Embodiment

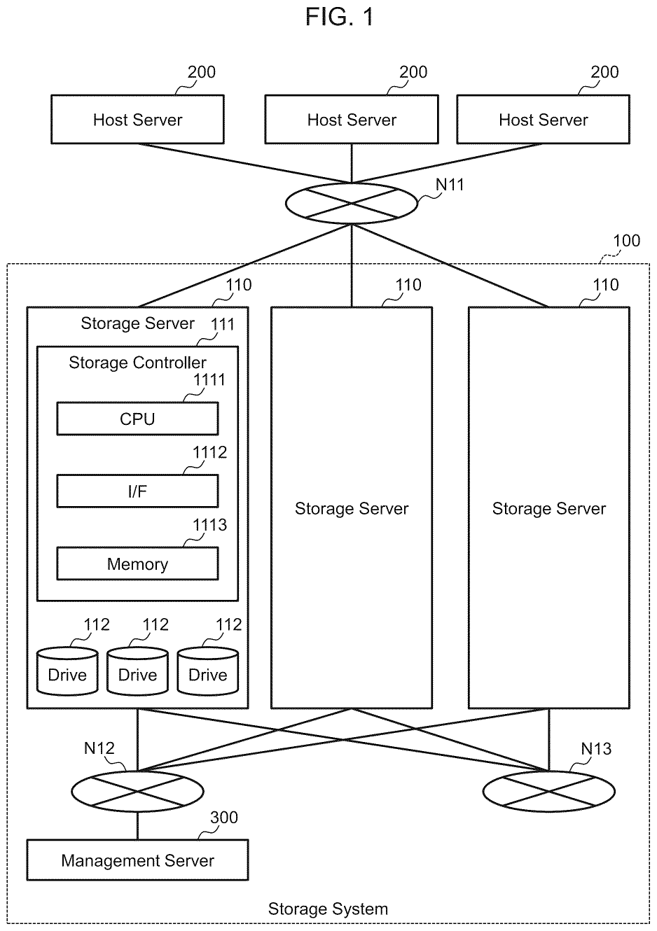

FIG. 1 depicts a configuration of an on-premises storage system 100 according to a first embodiment. The storage system 100 includes a plurality of storage servers 110 that are a plurality of nodes included in the storage system 100, and a management server 300. Each of the plurality of storage servers 110 is connected to host servers 200 through a network N11. The plurality of storage servers 110 are connected to the management server 300 through a network N12. The plurality of storage servers 110 are connected to each other through a network N13.

The host server 200 is a general-purpose computer that transmits a read request or a write request (they will collectively be referred to as an I/O request) to the storage server 110 according to a user operation or a request from an installed application program or the like. Note that the host server 200 may be a virtual computer apparatus such as a virtual machine.

The storage server 110 is a computer apparatus that provides the host server 200 with a storage area for reading and writing data. The storage server 110 is, for example, a general-purpose server apparatus. Each storage server 110 includes one or a plurality of storage controllers 111 and one or a plurality of drives 112.

The storage controller 111 includes a CPU 1111, an interface 1112, and a memory 1113. The storage controller 111 is a control function of SDS realized by the CPU 1111 executing software.

The CPU 1111 accesses the drive 112 according to an I/O request. The interface 1112 is an interface for the storage controller 111 to communicate with the host server 200, the management server 300, and the other storage servers 110. The memory 1113 stores programs and tables described later and executed by the CPU 1111 and functions as a cache memory when the CPU 1111 reads and writes data to and from the drive 112.

The management server 300 is a computer apparatus used by a system administrator to manage the entire storage system 100. The management server 300 collectively manages the plurality of storage servers 110 as a group called a cluster. Although only one cluster is provided in the example illustrated in FIG. 1, a plurality of clusters may be provided in the storage system 100.

### Logical Configuration of Storage Servers 110 According to First Embodiment

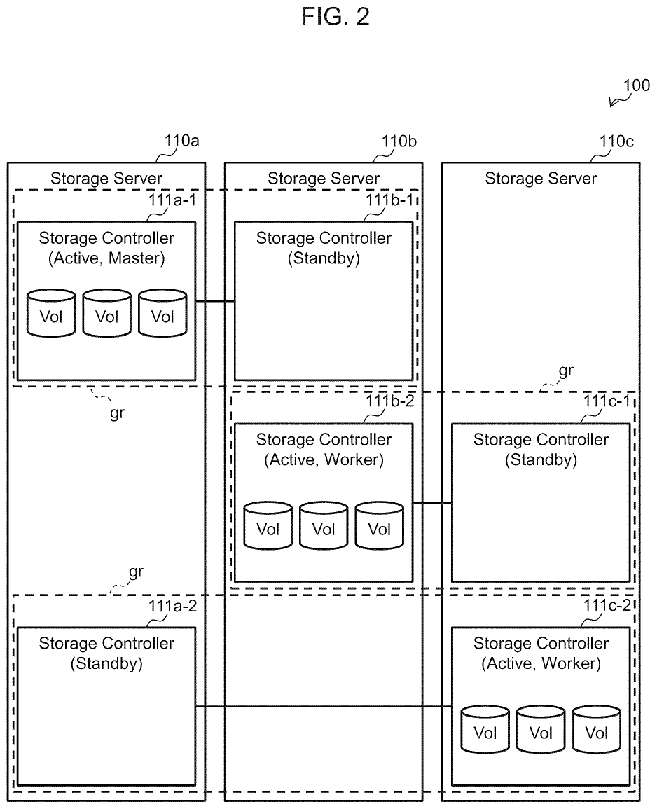

FIG. 2 depicts a logical configuration of the storage servers 110 according to the first embodiment.

In the example of the storage system 100 illustrated in FIG. 2, a storage controller 111a-1 of a storage server 110a and a storage controller 111b-1 of a storage server 110b form a mirroring controller group gr. In the example illustrated in FIG. 2, the storage controller 111a-1 is in a mirroring active mode, and the storage controller 111b-1 is in a mirroring standby mode.

The relation between a storage controller 111b-2 and a storage controller 111c-1 and the relation between a storage controller 111c-2 and a storage controller 111a-2 are similar to the relation between the storage controller 111a-1 and the storage controller 111b-1.

The storage controllers 111a-1, 111b-2, and 111c-2 execute processing in which the storage controller 111a-1 is a master and the storage controllers 111b-2 and 111c-2 are workers that cooperate under the control of the master.

### Logical Configuration When Failure Occurs in Storage Server 110a According to First Embodiment

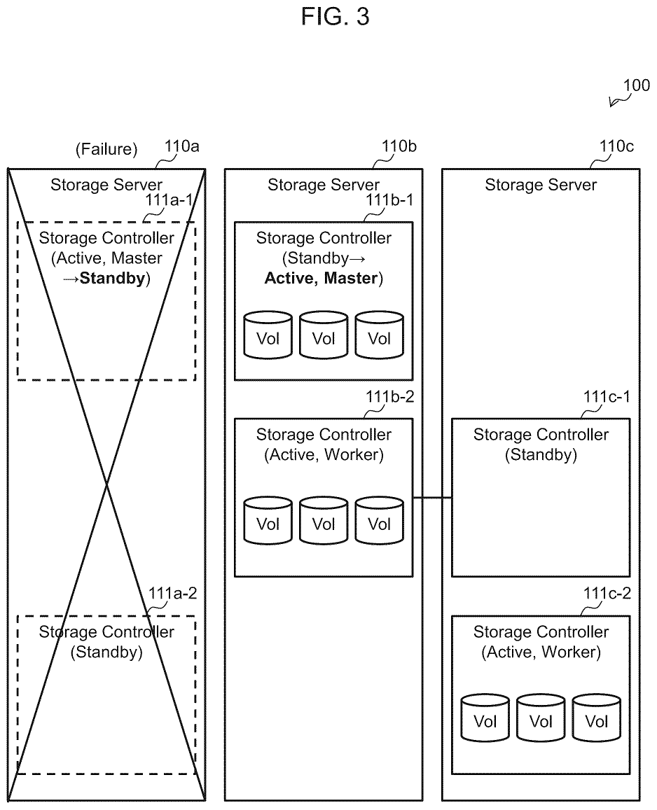

FIG. 3 depicts a logical configuration when a failure occurs in the storage server 110a according to the first embodiment. When a failure occurs in the storage server 110a and the storage controllers 111a-1 and 111a-2 become unusable, the storage controller 111a-1 shifts to the standby mode. The storage controller 111b-1 switches from the standby mode to the active mode and to the master, thereby replacing the storage controller 111a-1. Hereinafter, the storage server 110 in which a failure has occurred as in the storage server 110a will be referred to as a “failed node” in some cases.

### Chunk Configuration of Storage System 100 According to First Embodiment

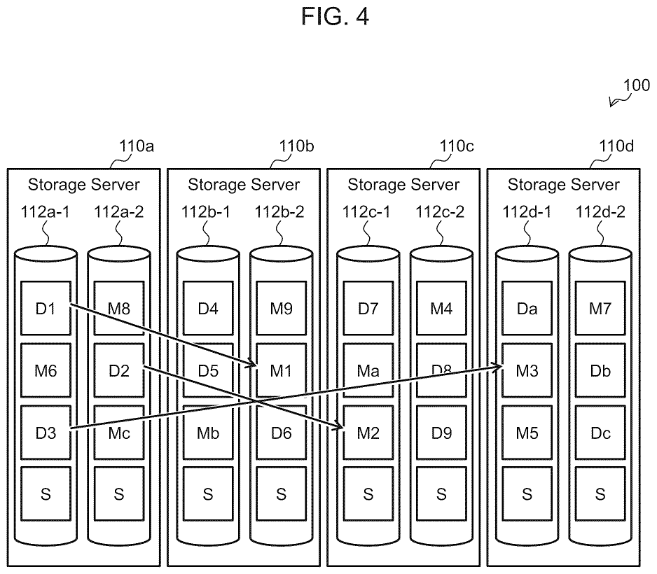

FIG. 4 depicts a chunk configuration of the storage system 100 according to the first embodiment.

In the example illustrated in FIG. 4, each storage server 110 included in the storage system 100 stores data in the drives 112 on the basis of chunks. Data chunks Dn (n=1 to 9, a to c) are chunks storing user data. Mirror chunks Mn (n=1 to 9, a to c) are mirror chunks corresponding to the data chunks Dn based on chunk mapping information managed in a chunk mapping table 92 described later. Spare chunks S are backup chunks reserved in the drives 112.

In the example of the storage system 100 illustrated in FIG. 4, the mirror chunk M1 as a mirror chunk stored in a drive 112b-2 of the storage server 110b corresponds to the data chunk D1 stored in a drive 112a-1 of the storage server 110a, for example.

### Correspondence Between Volume and Chunk of Storage System According to First Embodiment

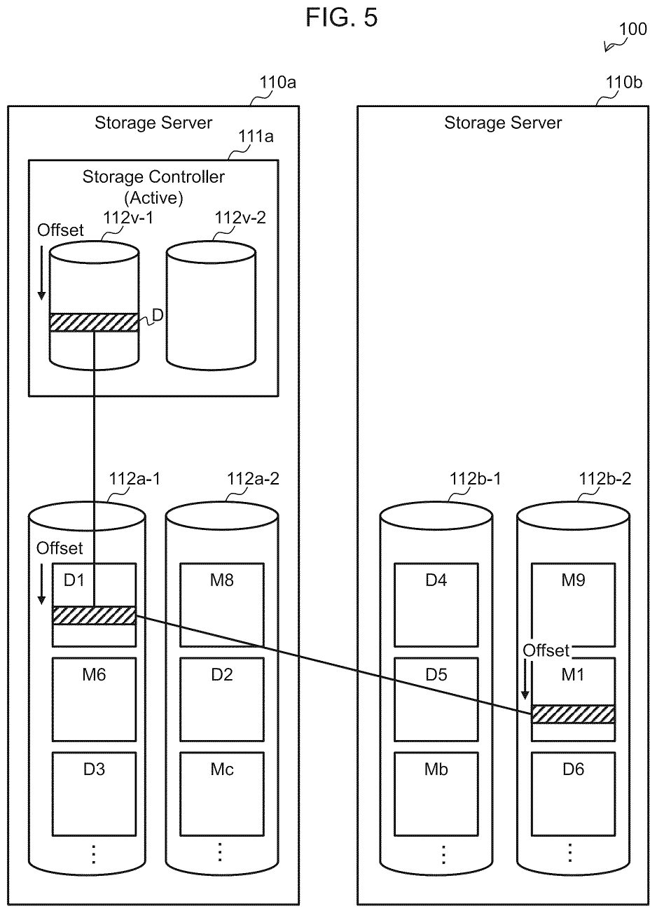

FIG. 5 depicts a correspondence between a volume and a chunk of the storage system according to the first embodiment.

In the example of the storage system 100 illustrated in FIG. 5, the storage controller 111a of the storage server 110a is in the active mode. The storage server 110a provides a virtual volume 112v to the host server 200. The storage controller 111a creates the virtual volume 112v based on the drive 112 of the storage server 110a.

Data D for which the storage position is indicated by an offset value in a virtual volume 112v-1 provided to the storage controller 111a is stored at the storage position indicated by an offset value in the data chunk D1 of the drive 112a-1, based on data mapping information managed in a data mapping table 94 described later. In this way, the storage system 100 of the present embodiment uses a read local system for constantly reading data from the drive 112 of the storage server 110 that has received an I/O request, when the I/O request of the data is received from the host (not illustrated) in normal times in which no node failure has occurred. That is, in normal times, the storage server 110 including the drive 112 storing the data has the ownership of the virtual volume 112v for receiving the data for which the I/O request is issued from the host.

The mirror data corresponding to the data D stored at the storage position indicated by the offset value in the data chunk D1 is stored at the storage position indicated by the offset value in the mirror chunk M1 that is a mirror chunk corresponding to the data chunk D1.

### Memory Configuration of Storage Server 110 According to First Embodiment

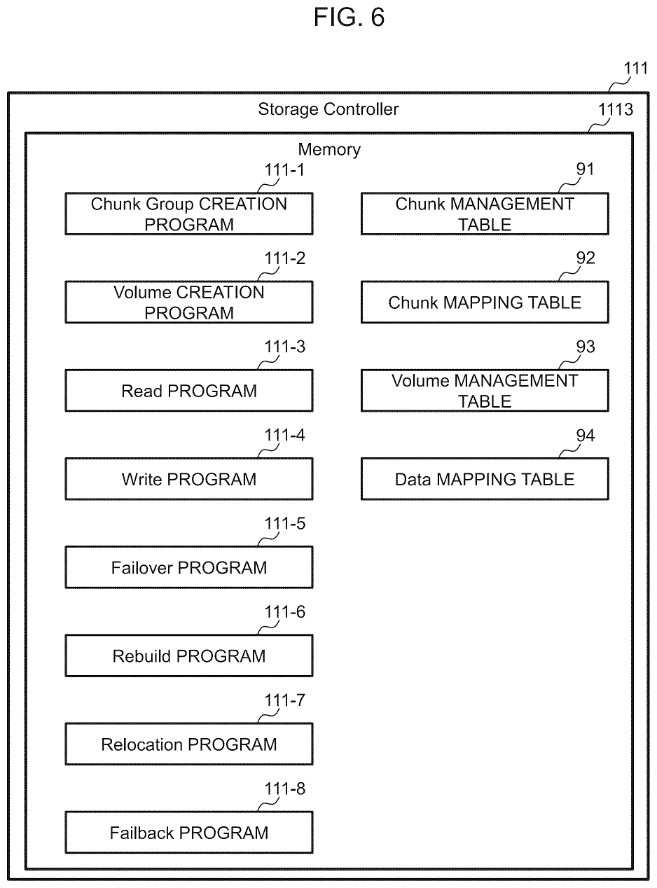

FIG. 6 depicts a configuration of the memory 1113 of the storage server 110 according to the first embodiment.

The memory 1113 stores a chunk group creation program 111-1, a volume creation program 111-2, a read program 111-3, and a write program 111-4. The memory 1113 also stores a failover program 111-5, a rebuild program 111-6, a relocation program 111-7, and a failback program 111-8. Processing functions of the programs will be described later with reference to flow charts.

The memory 1113 also stores a chunk management table 91, the chunk mapping table 92, a volume management table 93, and the data mapping table 94.

### Chunk Management Table 91 According to First Embodiment

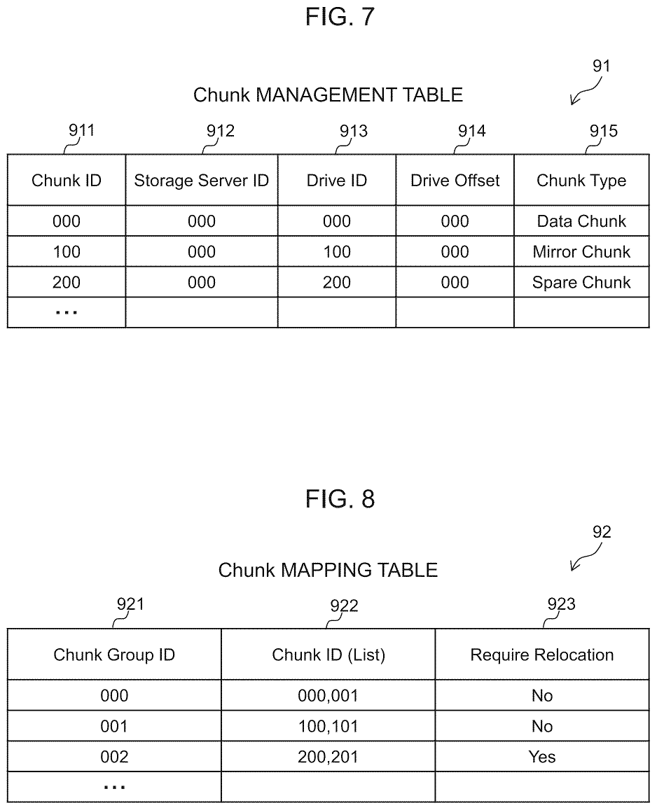

FIG. 7 depicts a configuration of the chunk management table 91 according to the first embodiment. The chunk management table 91 includes items including chunk ID 911, storage server ID 912, drive ID 913, drive offset 914, and chunk type 915. The chunk ID 911 is identification information of the chunk in the storage system 100. The storage server ID 912 is identification information of the storage server 110 storing the chunk in the storage system 100. The drive ID 913 is identification information of the drive 112 storing the chunk in the storage system 100. The drive offset 914 indicates the storage position of the chunk in the drive 112. The chunk type 915 indicates the type of the chunk which is one of the data chunk that stores the user data, the mirror chunk that stores the mirror data of the user data, and the spare chunk that copies and replaces the data of the data chunk or the mirror chunk of the failed node during rebuild.

### Chunk Mapping Table 92 According to First Embodiment

FIG. 8 depicts a configuration of the chunk mapping table 92 according to the first embodiment. The chunk mapping table 92 includes items including chunk group ID 921, chunk ID 922, and require relocation 923. The chunk group ID 921 is identification information of the chunk group in the storage system 100. The chunk ID 922 includes a list of chunks belonging to the chunk group identified by the chunk group ID 921. “Yes” in the require relocation 923 indicates that relocation for moving the mirror chunk Mn to the failed node is executed when the failed node is recovered after the rebuild of the mirror chunk Mn belonging to the chunk group identified by the chunk group ID 921. “No” in the require relocation 923 indicates that the relocation is not executed even when the failed node is recovered after the rebuild of the mirror chunk Mn belonging to the chunk group identified by the chunk group ID 921.

### Volume Management Table 93 According to First Embodiment

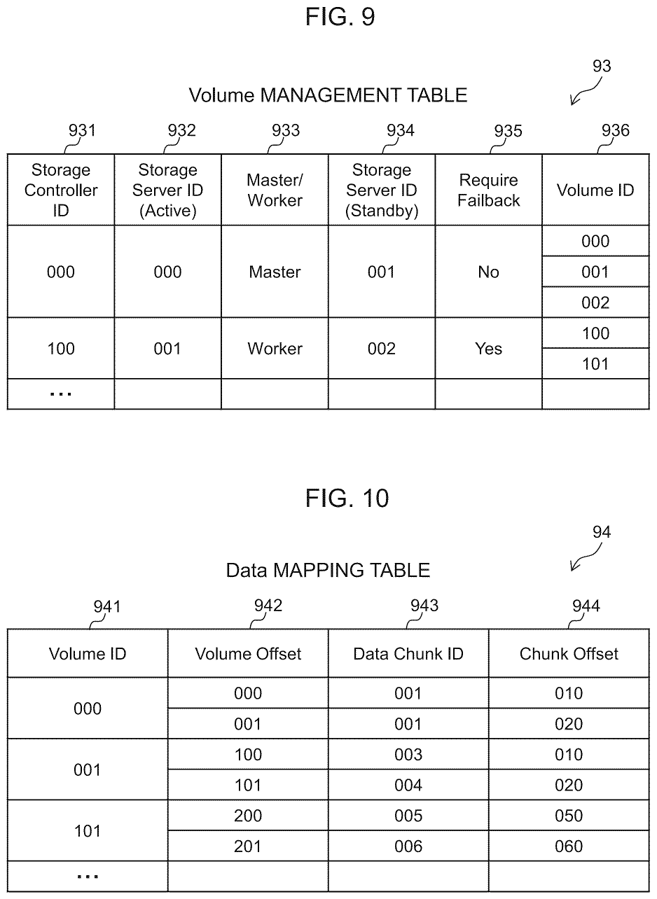

FIG. 9 depicts a configuration of the volume management table 93 according to the first embodiment. The volume management table 93 includes items including a storage controller ID 931, a storage server ID (active) 932, master/worker 933, a storage server ID (standby) 934, require failback 935, and volume ID 936.

The storage controller ID 931 is identification information of the storage controller 111 in the storage system 100. The storage server ID (active) 932 is identification information of the storage controller 111 in the active state in the controller group gr including the storage controller 111 in the storage system 100. The master/worker 933 indicates whether the storage controller 111 is a master or a worker. The storage server ID (standby) 934 is identification information of the storage controller 111 in the standby state in the controller group gr including the storage controller 111 in the storage system 100. The require failback 935 indicates whether failback is required. The volume ID 936 is identification information of the virtual volumes 112v managed by the storage controller 111 in the storage system 100.

“Yes” in the require failback 935 indicates that failback for switching the active state and the standby state of the storage controllers 111 is executed after the rebuilt mirror chunk Mn is relocated to the recovered failed node. “No” in the require failback 935 indicates that the failback is not executed even after the rebuilt mirror chunk Mn is relocated to the recovered failed node.

### Data Mapping Table 94 According to First Embodiment

FIG. 10 depicts a configuration of the data mapping table 94 according to the first embodiment. The data mapping table 94 includes items including volume ID 941, volume offset 942, data chunk ID 943, and chunk offset 944. The volume ID 941 is identification information of the virtual volume 112v (FIG. 5) in the storage system 100. The volume offset 942 includes offset values indicating the storage positions of the data D (FIG. 5) in the virtual volume 112v identified by the volume ID 941. The data chunk ID 943 is identification information of the data chunks Dn storing the data D in the storage system 100. The chunk offset 944 includes offset values indicating the storage positions of the data D in the data chunks Dn identified by the data chunk ID 943.

### Chunk Group Creation Process According to First Embodiment

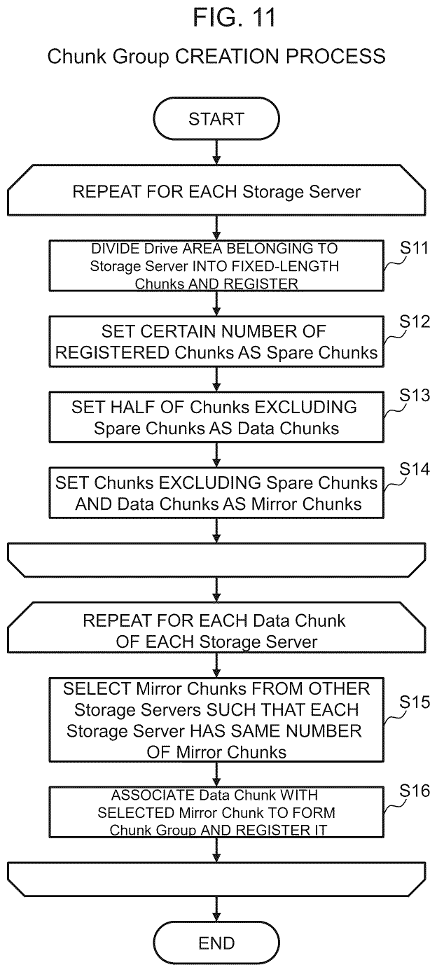

FIG. 11 is a flow chart illustrating a chunk group creation process according to the first embodiment. The volume creation program 111-2 (FIG. 6) of the active master storage server 110 is triggered by a user instruction input from the management server 300 or the like to execute the chunk group creation process when, for example, a storage server 110 is newly added.

In step S11, the volume creation program 111-2 divides the storage area of the drive 112 belonging to the storage server 110 to be processed into fixed-length chunks and registers the chunks. In step S12, the chunk group creation program 111-1 sets a certain number of chunks registered in step S11, as spare chunks S.

In step S13, the chunk group creation program 111-1 sets half the chunks excluding the spare chunks S set in step S12 as data chunks Dn. In step S14, the chunk group creation program 111-1 sets the chunks excluding the spare chunks S set in step S12 and the data chunks Dn set in step S13, as mirror chunks Mn.

When steps S11 through S14 are finished for one storage server 110, the chunk group creation program 111-1 executes steps S11 through S14 for the next unselected storage server 110.

When steps S11 through S14 are finished for all storage servers 110, the chunk group creation program 111-1 repeats steps S15 and S16 for all data chunks Dn of all storage servers 110.

In step S15, the chunk group creation program 111-1 selects, from each of the storage servers 110 other than the storage server 110 to be processed, the same number of mirror chunks Mn to be associated with the data chunks Dn of the storage server 110.

In step S16, the chunk group creation program 111-1 associates the data chunk Dn of the storage server 110 to be processed with the mirror chunk Mn selected in step S15, to form a chunk group, and registers the chunk group in the chunk management table 91 and the chunk mapping table 92.

When steps S15 and S16 are finished for one data chunk Dn of one storage server 110, the chunk group creation program 111-1 executes steps S15 and S16 for the next unselected data chunk Dn of the storage server 110. When steps S15 and S16 are finished for the data chunks Dn of all storage servers 110, the chunk group creation program 111-1 ends the chunk group creation process.

### Volume Creation Process According to First Embodiment

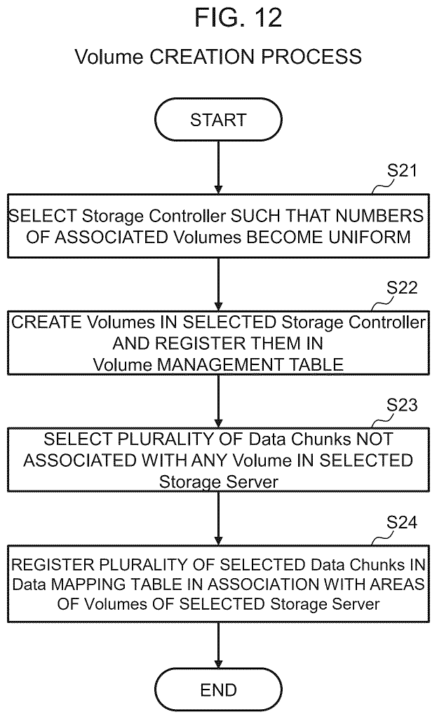

FIG. 12 is a flow chart illustrating a volume creation process according to the first embodiment. The volume creation program 111-2 (FIG. 6) of the master active storage controller 111 is triggered by a user instruction input from the management server 300 or the like to execute the volume creation process after the execution of the chunk group creation process or the like.

In step S21, the volume creation program 111-2 selects the storage controller 111 such that the virtual volumes 112v to be created are uniformly allocated to the storage controllers 111. In step S22, the volume creation program 111-2 creates the virtual volumes 112v in the storage controller 111 selected in step S21 and registers the virtual volumes 112v in the volume management table 93.

In step S23, the volume creation program 111-2 selects a plurality of data chunks Dn not associated with any virtual volume 112v in the storage server 110 including the storage controller 111 selected in step S21. In step S24, the volume creation program 111-2 registers, in the data mapping table 94, the data chunks Dn selected in step S23 in association with the virtual volumes 112v created in the same storage server 110 storing the data chunks Dn.

### Series of Processes from Occurrence of Node Failure to Recovery of Node Failure According to First Embodiment

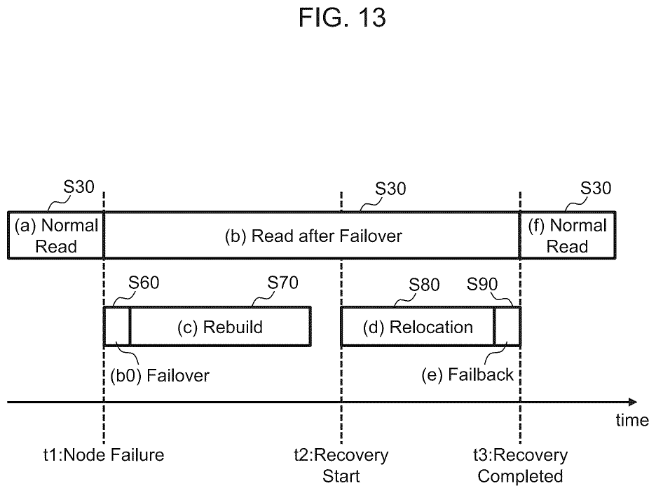

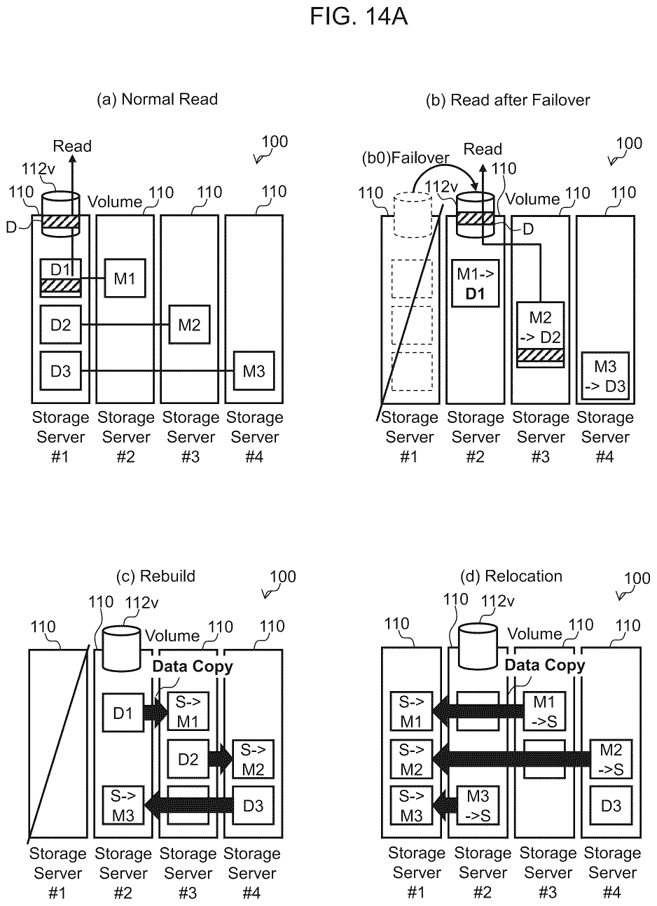

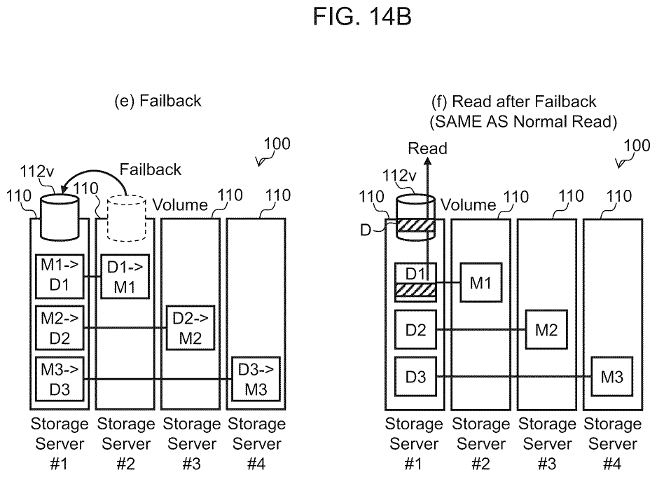

FIG. 13 is a timing chart illustrating a series of processes executed from the occurrence of node failure to the recovery of node failure, in the storage system 100 according to the first embodiment. FIG. 14A depicts outlines of a normal read process, a read process after failover, a rebuild process, and a relocation process executed in the storage system 100 according to the first embodiment. FIG. 14B depicts outlines of a failback process and a read process after failback executed in the storage system 100 according to the first embodiment.

As illustrated in FIGS. 13 and 14A, the storage system 100 sets the storage server 110 (#1) as an owner node that is provided with the data chunks D1, D2, and D3 and that provides the virtual volumes 112v to the host server 200. The storage system 100 distributes and arranges the mirror chunks M1, M2, and M3 in the storage servers 110 (#1 to #3), respectively.

Until time t1, the data chunk D1 is accessed for reading the data D (read process S30; (a) normal read (FIG. 13, FIG. 14A)).

At time t1, a node failure occurs in the storage server 110 (#1) to be read of the storage system 100, and the storage server 110 (#1) becomes unreadable. A failover process S60 of shifting the ownership of the virtual volume 112v from the storage server 110 (#1) to the storage server 110 (#2) is executed ((b0) failover (FIG. 13, FIG. 14A)). As for the ownership of the virtual volume 112v, one specific storage server 110 provided with the ownership processes the I/O request for the virtual volume 112v. The mirror chunk M1 shifts to the data chunk D1. The mirror chunk M2 shifts to the data chunk D2. The mirror chunk M3 shifts to the data chunk D3.

After the failover, the data chunk D2 is accessed for reading the data D ((b) read after failover (FIG. 13, FIG. 14A)). The data D is output by use of redundant data read from a plurality of storage servers 110 including the storage server 110 (storage server #2) including the storage controller 111 changed to the active state and other storage servers 110 (storage servers #3 and #4).

When the failover process S60 is finished, a rebuild process S70 of restoring the redundant configuration is executed ((c) rebuild (FIG. 13, FIG. 14A)). That is, the data chunk D1 of the storage server 110 (#2) is copied to the spare chunk S of the storage server 110 (#3), and the spare chunk S is set as the mirror chunk M1. Similarly, the data chunk D2 of the storage server 110 (#3) is copied to the spare chunk S of the storage server 110 (#4), and the spare chunk S is set as the mirror chunk M2. Similarly, the data chunk D3 of the storage server 110 (#4) is copied to the spare chunk S of the storage server 110 (#2), and the spare chunk S is set as the mirror chunk M3. That is, the nodes that store the data rebuilt from the redundant data distributed and stored in a plurality of nodes (storage servers 110) are nodes different from the nodes storing the corresponding redundant data. Furthermore, the nodes that store the rebuilt data are nodes storing other redundant data different from the corresponding redundant data.

At time t2, a relocation process S80 of integrating the mirror chunks M1 through M3 into the storage server 110 (#1) is executed ((d) relocation (FIG. 13, FIG. 14A)). That is, the mirror chunk M1 of the storage server 110 (#3) is copied to the spare chunk S of the storage server 110 (#1) recovered from the node failure, and the spare chunk S is set as the mirror chunk M1. Similarly, the mirror chunk M2 of the storage server 110 (#4) is copied to the spare chunk S of the storage server 110 (#1) recovered from the node failure, and the spare chunk S is set as the mirror chunk M2. Similarly, the mirror chunk M3 of the storage server 110 (#2) is copied to the spare chunk S of the storage server 110 (#1) recovered from the node failure, and the spare chunk S is set as the mirror chunk M3. After the data is copied to the spare chunks S, the mirror chunk M1 of the storage server 110 (#3), the mirror chunk M2 of the storage server 110 (#4), and the mirror chunk M3 of the storage server 110 (#2) are set as the spare chunks S in the respective storage servers 110.

When the relocation is finished, a failback process S90 of returning the ownership to the recovered storage server 110 (#1) is executed ((e) failback (FIG. 13, FIG. 14B). That is, the virtual volume 112v is moved from the storage server 110 (#2) to the storage server 110 (#1). The mirror chunk M1 of the storage server 110 (#1) is shifted to the data chunk D1, and the data chunk D1 of the storage server 110 (#2) is shifted to the mirror chunk M1. Similarly, the mirror chunk M2 of the storage server 110 (#1) is shifted to the data chunk D2, and the data chunk D2 of the storage server 110 (#3) is shifted to the mirror chunk M2. Similarly, the mirror chunk M3 of the storage server 110 (#1) is shifted to the data chunk D3, and the data chunk D3 of the storage server 110 (#4) is shifted to the mirror chunk M3.

After time t3, the data chunk D1 is accessed for reading the data D as in (a) normal read ((f) read after failback (FIG. 13, FIG. 14A)). That is, when the data distributed and stored in a plurality of nodes through the rebuild is copied to the node including the storage controller in the active state before the failover and the failback is performed, the storage controller in the active state of the node with the copied data uses the data copied to the node to input and output data.

### Read Process S30 According to First Embodiment

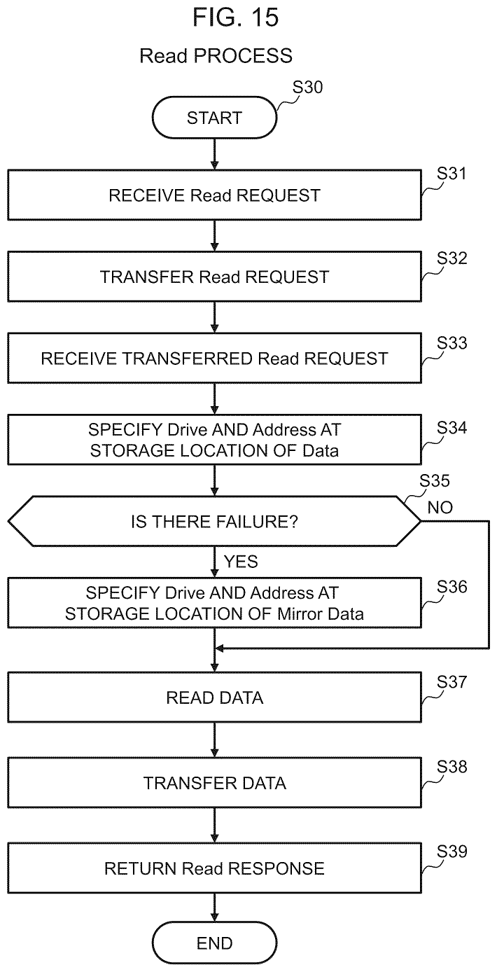

FIG. 15 is a flow chart illustrating the read process S30 according to the first embodiment.

In step S31, the read program 111-3 of the storage controller 111 (active) of one of the storage servers 110 receives a read request from the host server 200. In step S32, the read program 111-3 that has received the read request in step S31 transfers the read request to the storage server 110 (with the ownership) including the storage controller 111 (active) corresponding to the virtual volume 112v for which the read request has been made.

In step S33, the read program 111-3 of the storage controller 111 (active) with the ownership receives the read request transferred in step S32. In step S34, the read program 111-3 of the storage controller 111 (active) with the ownership specifies the drive 112 and the address (offset value) at the storage location of the read data regarding the read request.

In step S35, the read program 111-3 of the storage controller 111 (active) with the ownership determines whether there is a failure in the storage controller 111 including the drive 112 specified in step S34. The read program 111-3 of the storage controller 111 (active) with the ownership moves the process to step S36 if there is a failure in the storage controller 111 including the drive 112 specified in step S34 (step S35, YES) and moves the process to step S37 if there is no failure (step S35, NO).

In step S36, the read program 111-3 of the storage controller 111 (active) with the ownership specifies the drive 112 storing the mirror chunk Mn at the storage location of the mirror data and the address (offset value) at the storage location.

In step S37, the read program 111-3 of the storage controller 111 (active) with the ownership reads the read data from the drive 112 specified in step S34 or S36. Here, when the specified drive 112 is a drive 112 of a storage server 110 other than the storage server 110 including the read program 111-3, the read program 111-3 of the storage controller 111 (active) with the ownership requests the read program 111-3 of the storage controller 111 of the storage server 110 including the target drive 112 to read the read data through the network N13.

In step S38, the read program 111-3 of the storage controller 111 (active) with the ownership transfers the read data read in step S37 to the storage controller 111 that has received the read request from the host server 200 in step S31. In step S39, the read program 111-3 of the storage controller 111 that has received the read request returns the read data transferred in step S38 as a read response to the host server 200.

### Write Process According to First Embodiment

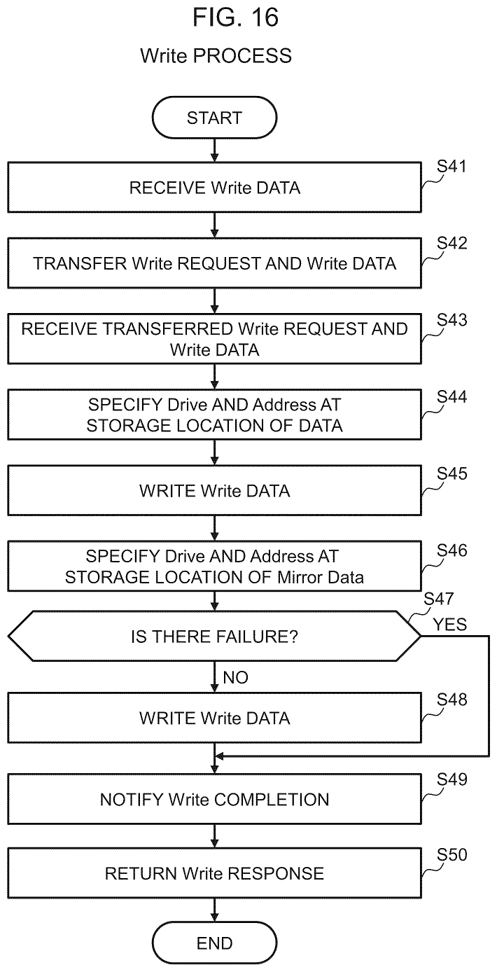

FIG. 16 is a flow chart illustrating a write process according to the first embodiment. The write process according to the first embodiment is executed in place of or at the same time as the read process (FIG. 15) according to the first embodiment.

In step S41, the write program 111-4 of the storage controller 111 (active) of one of the storage servers 110 receives a write request and write data from the host server 200. In step S42, the write program 111-4 that has received the write request in step S41 transfers the write request and the write data to the storage server 110 (with the ownership) including the storage controller 111 (active) corresponding to the virtual volume 112v for which the write request has been made.

In step S43, the write program 111-4 of the storage controller 111 (active) with the ownership receives the write request and the write data. In step S44, the write program 111-4 of the storage controller 111 (active) with the ownership specifies the drive 112 and the address (offset value) storing the data chunk Dn at the storage location of the write data.

In step S45, the write program 111-4 of the storage controller 111 (active) with the ownership writes the write data to the address of the drive 112 specified in step S44.

In step S46, the write program 111-4 of the storage controller 111 (active) with the ownership specifies the drive 112 and the address (offset value) storing the mirror chunk Mn at the storage location of the mirror data of the write data. In step S47, the write program 111-4 of the storage controller 111 (active) with the ownership determines whether there is a failure in the storage controller 111 including the drive 112 specified in step S46. The write program 111-4 of the storage controller 111 (active) with the ownership moves the process to step S49 if there is a failure in the storage controller 111 including the drive 112 specified in step S46 (step S47, YES) and moves the process to step S48 if there is no failure (step S47, NO).

In step S48, the write program 111-4 of the storage controller 111 (active) with the ownership requests the write program 111-4 of the storage controller 111 of the storage server 110 including the drive 112 specified in step S46 to write the write data through the network N13.

In step S49, the write program 111-4 of the storage controller 111 (active) with the ownership notifies the storage controller 111 that has received the write request from the host server 200 in step S41 of the write completion regarding the write data written in step S48. In step S50, the write program 111-4 of the storage controller 111 that has received the write request returns a write response to the host server 200 in response to the write completion notified in step S49.

### Failover Process S60 According to First Embodiment

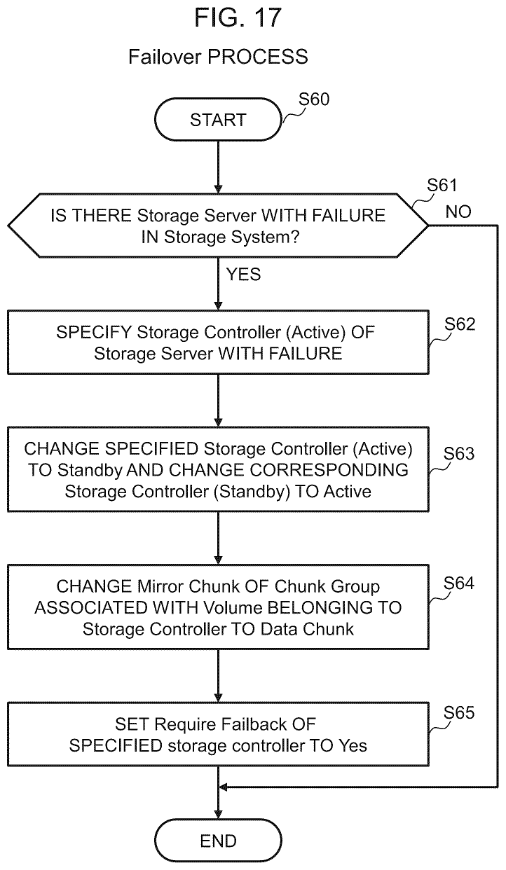

FIG. 17 is a flow chart illustrating the failover process S60 according to the first embodiment. The failover program 111-5 (FIG. 6) of the master active storage controller 111 periodically executes the failover process S60.

In step S61, the failover program 111-5 determines whether there is a storage server 110 with a failure in the storage system 100. The failover program 111-5 moves the process to step S62 if there is a storage server 110 with a failure in the storage system 100 (step S61, YES). On the other hand, the failover program 111-5 ends the failover process S60 if there is no storage server 110 with a failure in the storage system 100 (step S61, NO).

In step S62, the failover program 111-5 specifies the storage controller 111 (active) of the storage server 110 determined to have a failure in step S61. In step S63, the failover program 111-5 changes the storage controller 111 (active) specified in step S62 to the standby state and changes the corresponding storage controller 111 (standby) to the active state.

In step S64, the failover program 111-5 changes the mirror chunk Mn of the chunk group associated with the virtual volume 112v belonging to the storage controller 111 to the data chunk Dn.

In step S65, the failover program 111-5 sets the require failback 935 (FIG. 9) of the storage controller 111 specified in step S62 to “Yes.”

### Rebuild Process S70 According to First Embodiment

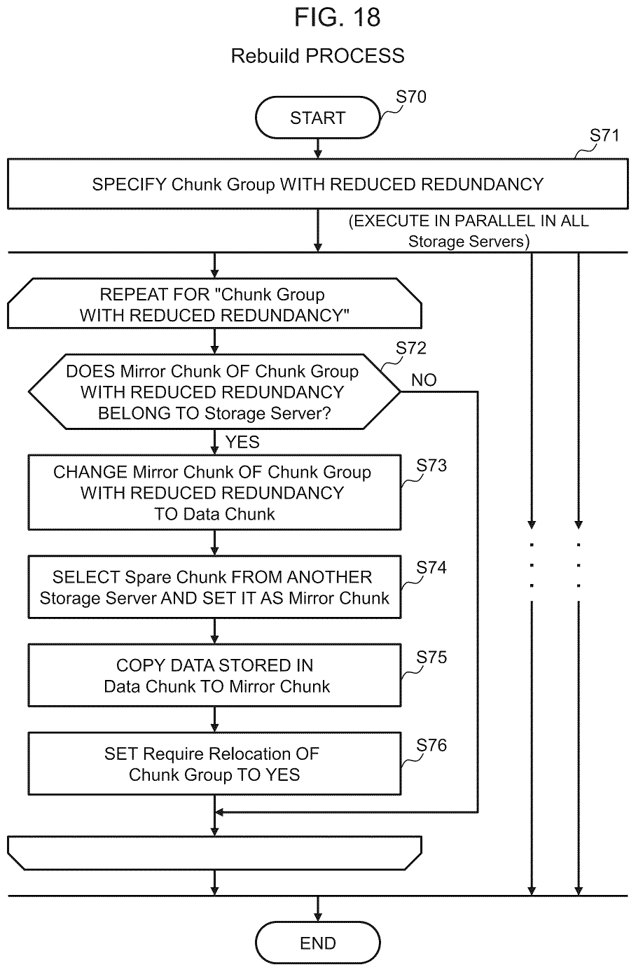

FIG. 18 is a flow chart illustrating the rebuild process S70 according to the first embodiment. The rebuild program 111-6 (FIG. 6) of the master active storage controller 111 executes the rebuild process S70 when a failure occurs in the storage system 100.

In step S71, the rebuild program 111-6 specifies the chunk group including the data chunk Dn in the storage server 110 with a failure as a “chunk group with reduced redundancy.”

The rebuild programs 111-6 of all storage servers 110 repetitively execute, in parallel, steps S72 through S76 for the “chunk group with reduced redundancy” specified in step S71.

In step S72, the rebuild program 111-6 determines whether the mirror chunk Mn of the “chunk group with reduced redundancy” to be processed belongs to the storage server 110 including the rebuild program 111-6. The rebuild program 111-6 moves the process to step S73 if the mirror chunk Mn of the “chunk group with reduced redundancy” to be processed belongs to the storage server 110 including the rebuild program 111-6 (step S72, YES). On the other hand, the rebuild program 111-6 selects the next “chunk group with reduced redundancy” to be processed and repeats step S72 if the mirror chunk Mn of the “chunk group with reduced redundancy” to be processed belongs to another storage server 110 (step S72, NO).

In step S73, the rebuild program 111-6 changes the mirror chunk Mn of the “chunk group with reduced redundancy” to the data chunk Dn. In step S74, the rebuild program 111-6 selects the spare chunk S from a storage server 110 different from the storage server 110 including the rebuild program 111-6 and sets the spare chunk S as the mirror chunk Mn.

In step S75, the rebuild program 111-6 copies the data stored in the data chunk Dn to the mirror chunk Mn. In step S76, the rebuild program 111-6 sets the require relocation 923 (FIG. 8) of the “chunk group with reduced redundancy” to be processed to “Yes.”

When step S76 is finished, the rebuild program 111-6 selects the next “chunk group with reduced redundancy” to be processed and returns the process to step S72. When steps S72 through S76 are finished for all “chunk groups with reduced redundancy,” the rebuild program 111-6 ends the rebuild process.

### Relocation Process S80 According to First Embodiment

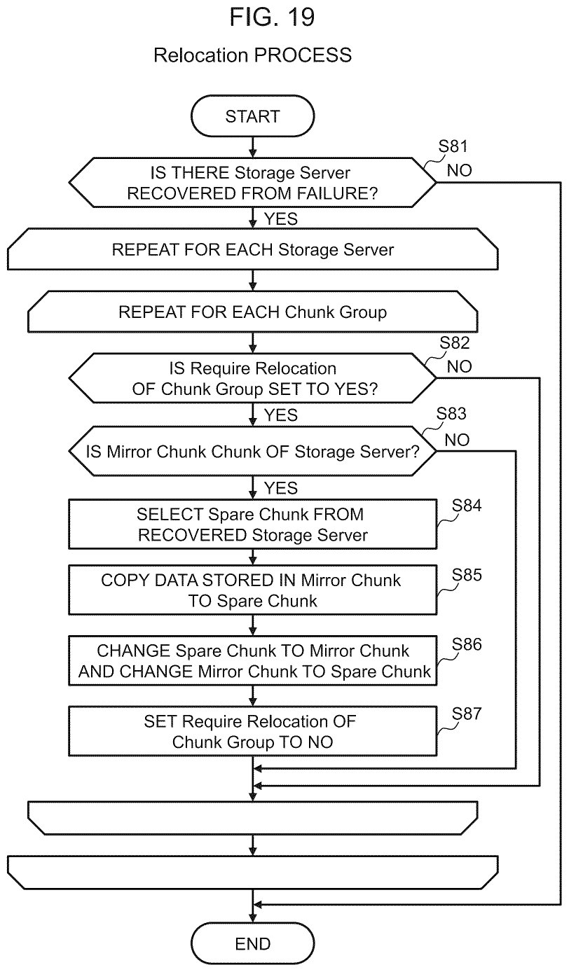

FIG. 19 is a flow chart illustrating the relocation process S80 according to the first embodiment. The relocation program 111-7 (FIG. 6) of the master active storage controller 111 executes the relocation process S80 after the end of the rebuild process S70 (FIG. 18).

In step S81, the relocation program 111-7 determines whether there is a storage server 110 recovered from a failure in the storage system 100. The relocation program 111-7 moves the process to step S82 if there is a storage server 110 recovered from a failure in the storage system 100 (step S81, YES). On the other hand, the relocation program 111-7 ends the relocation process S80 if there is no storage server 110 recovered from a failure in the storage system 100 (step S81, NO).

The relocation program 111-7 repeats steps S82 through S87 for all storage servers 110 and all chunk groups.

In step S82, the relocation program 111-7 determines whether the require relocation 923 (FIG. 8) is set to “Yes” for the chunk group of the storage server 110 to be processed. The relocation program 111-7 moves the process to step S83 if the require relocation 923 is set to “Yes” for the chunk group of the storage server 110 to be processed (step S82, YES). On the other hand, the relocation program 111-7 selects the chunk group of the next storage server 110 to be processed and repeats step S82 if the require relocation 923 is set to “No” for the chunk group of the storage server 110 to be processed (step S82, NO).

In step S83, the relocation program 111-7 determines whether the mirror chunk Mn of the chunk group to be processed is a chunk of the storage server 110 including the relocation program 111-7. The relocation program 111-7 moves the process to step S84 if the mirror chunk Mn of the chunk group to be processed is a chunk of the storage server 110 including the relocation program 111-7 (step S83, YES). On the other hand, the relocation program 111-7 selects the chunk group of the next storage server 110 to be processed and returns the process to step S82 if the mirror chunk Mn of the chunk group to be processed is a chunk of another storage server 110 (step S83, NO).

In step S84, the relocation program 111-7 selects the spare chunk S from the storage server 110 recovered from the failure. In step S85, the relocation program 111-7 copies the data stored in the mirror chunk Mn to the spare chunk S selected in step S84.

In step S86, the relocation program 111-7 switches the spare chunk S in which the data stored in the mirror chunk Mn is copied in step S85 and the mirror chunk Mn. The relocation program 111-7 sets the spare chunk S as the mirror chunk Mn and sets the mirror chunk Mn as the spare chunk S.

In step S87, the relocation program 111-7 changes the require relocation 923 (FIG. 8) of the chunk group to be processed to “No.” When step S87 is finished, the relocation program 111-7 selects the next chunk group to be processed and returns the process to step S82.

When steps S82 through S87 are finished for all chunk groups of the storage server 110 to be processed, the relocation program 111-7 selects the next storage server 110 to be processed and returns the process to step S82. When steps S82 through S87 are finished for all storage servers 110 to be processed, the relocation program 111-7 ends the relocation process S80.

### Failback Process S90 According to First Embodiment

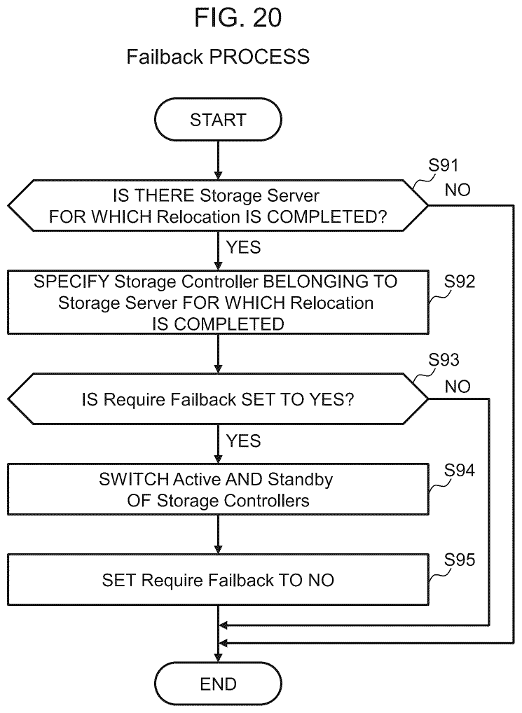

FIG. 20 is a flow chart illustrating the failback process S90 according to the first embodiment. The failback program 111-8 (FIG. 6) of the master active storage controller 111 executes the failback process S90 after the end of the relocation process S80 (FIG. 19).

In step S91, the failback program 111-8 determines whether there is a storage server 110 for which the relocation process S80 is completed in the storage system 100. The failback program 111-8 moves the process to step S92 if there is a storage server 110 for which the relocation process S80 is completed (step S91, YES) and ends the failback process S90 if there is no storage server 110 for which the relocation process S80 is completed (step S91, NO).

In step S92, the failback program 111-8 specifies the storage controller 111 belonging to the storage server 110 for which the relocation process S80 is completed. In step S93, the failback program 111-8 refers to the volume management table 93 (FIG. 9) to determine whether the require failback 935 (FIG. 9) of the storage server 110 specified in step S92 is set to “Yes.” The failback program 111-8 moves the process to step S94 if the require failback 935 is set to “Yes” (step S93, YES) and ends the failback process S90 if the require failback 935 is set to “No” (step S93, NO).

In step S94, the failback program 111-8 switches the “active state” and the “standby state” between the storage controller 111 for which the relocation process S80 is determined to have been completed in step S92 and the original storage controller 111 of the relocation process S80.

In step S95, the failback program 111-8 sets the require failback 935 (FIG. 9) determined to be set to “Yes” in step S93 to “No.”

Although the first embodiment is based on the capacity management method in which the chunk is the basic unit of the capacity management of the storage area, other capacity management methods, such as thin provisioning, may also be adopted.

### Effects of First Embodiment

In the first embodiment, the plurality of user data areas (data chunks) are associated with the virtual volumes created in the node (storage server) such that the node becomes the owner node that receives the I/O request from the host for the user data stored in the plurality of user data areas included in the drive included in the node. Therefore, according to the first embodiment, the user data can be read fast by the read local system in normal times, and fast distributed rebuild is possible because the mirror data is distributed to the plurality of storage servers. That is, the performance of the distributed rebuild system and the performance of the read local system can be balanced in the storage system.

In the first embodiment, the user data stored in the user data area belonging to the same redundant group (chunk group) is restored in the spare area included in a node other than the failed node and the node including the redundant data area (mirror chunk) in the rebuild, based on the redundant data (mirror data) stored in the redundant data area belonging to the same redundant group. Therefore, according to the first embodiment, fast distributed rebuild is possible when a failure occurs in the storage server of the read local system.

In the first embodiment, the user data restored through the execution of the rebuild is rearranged in the failed node when the failed node is recovered, and the failed node is set as the owner node when the rearrangement of the user data in the failed node is finished. Therefore, according to the first embodiment, the read local in the failed node can be recovered after the recovery of the failed node.

### Second Embodiment

The mirroring configuration including the data chunks and the mirror chunks in the redundant configuration is described in the first embodiment. However, the redundant configuration is not limited to the mirroring configuration. A redundant configuration of erasure coding will be described in a second embodiment, in which the redundant configuration includes codes for data restoration stored in one or more other storage servers different from the storage server at the storage location of the user data.

In the erasure coding of the present embodiment, redundant data is created based on a plurality of pieces of user data stored in different storage servers (nodes) with different redundancy groups. The created redundant data is stored in a node not storing any of the plurality of pieces of user data from which the redundant data is created. Chunks include the redundant data and the plurality of pieces of user data from which the redundant data is created. The other user data and the redundant data included in the chunks regarding the user data in one redundancy group are distributed and stored in a larger number of nodes than the number of pieces of data.

The mirroring and the erasure coding can be mixed in the second embodiment.

### Chunk Configuration of Storage System 100B According to Second Embodiment

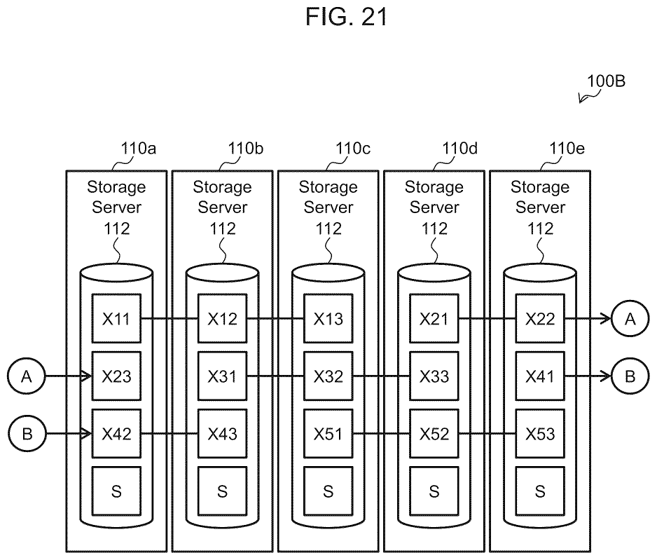

FIG. 21 depicts a chunk configuration of a storage system 100B according to the second embodiment.

FIG. 21 illustrates an example of adopting the redundant configuration of xDyP(x+Y=3) erasure coding. “Xpq” represents a qth chunk of a pth chunk group. For example, in FIG. 21, a first chunk group includes the chunk X11 stored in the drive 112 of the storage server 110a, the chunk X12 stored in the drive 112 of the storage server 110b, and the chunk X13 stored in the drive 112 of the storage server 110c. A second chunk group includes the chunk X21 stored in the drive 112 of the storage server 110d, the chunk X22 stored in the drive 112 of the storage server 110e, and the chunk X23 stored in the drive 112 of the storage server 110a.

### Configuration of Chunk Management Table 91B According to Second Embodiment

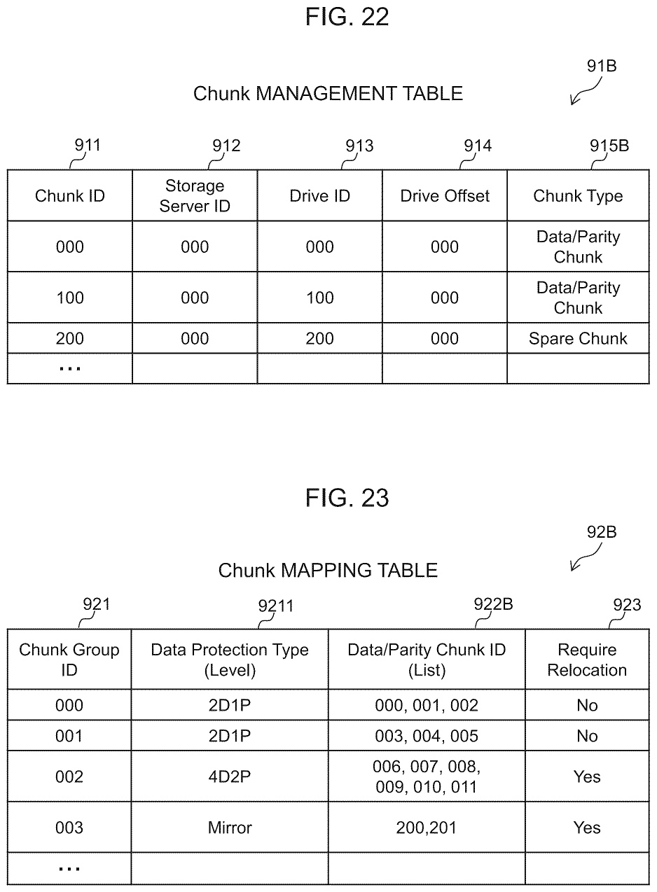

FIG. 22 depicts a configuration of a chunk management table 91B according to the second embodiment. Compared to the chunk management table 91 according to the first embodiment, the chunk management table 91B includes an item of chunk type 915B in place of the chunk type 915. The chunk type 915B indicates the type of the chunk which is one of the data chunk that stores the user data, the parity chunk that stores the parity of the user data, and the spare chunk that copies and replaces the data of the data chunk or the parity chunk of the failed node during rebuild.

### Configuration of Chunk Mapping Table 92B According to Second Embodiment

FIG. 23 depicts a configuration of a chunk mapping table 92B according to the second embodiment. Compared to the chunk mapping table 92 according to the first embodiment, the chunk mapping table 92B further includes an item of data protection type 9211 and includes an item of data/parity chunk ID 922B in place of the chunk ID 922.

The data protection type 9211 indicates the type of redundant configuration, which is one of erasure coding and mirroring, including the chunks of the chunk group identified by the chunk group ID and indicates the protection level in the case of erasure coding. The data/parity chunk ID 922B includes a list of chunks belonging to the chunk group ID 921.

For example, the chunk group with the chunk group ID 921 of “000” in FIG. 23 has a redundant configuration of 2D1P erasure coding, and the identification information of the belonging chunks includes “000,” “001,” and “002.” The chunk group with the chunk group ID 921 of “003” has a redundant configuration of mirroring, and the identification information of the belonging chunks includes “200” and “201.”

### Series of Processes from Occurrence of Node Failure to Recovery of Node Failure According to Second Embodiment

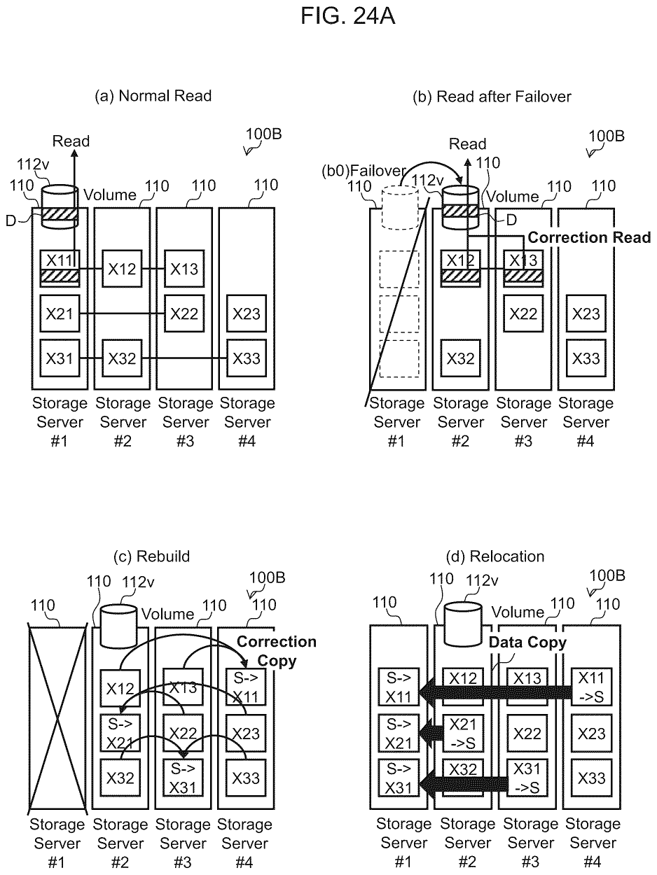

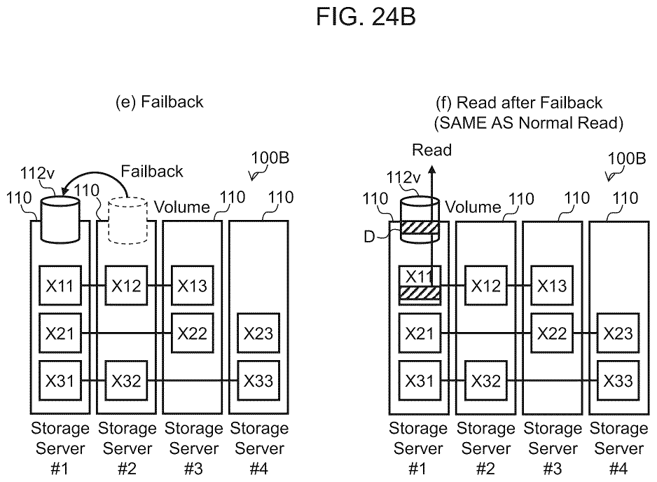

FIG. 24A depicts outlines of a normal read process, a read process after failover, a rebuild process, and a relocation process executed in the storage system 100B according to the second embodiment. FIG. 24B depicts outlines of a failback process and a read process after failback executed in the storage system according to the second embodiment. FIG. 13 will also be referenced in the description of FIGS. 24A and 24B.

As illustrated in FIG. 24A, the storage system 100B sets the storage server 110 (#1) as an owner node that is provided with the chunks X11, X21, and X31 and that provides the virtual volumes 112v to the host server 200. The storage system 100B includes the chunks X12 and X32 arranged in the storage server 110 (#2). The storage system 100B includes the chunks X13 and X22 arranged in the storage server 110 (#3). The storage system 100B includes the chunks X23 and X33 arranged in the storage server 110 (#4).

Until time t1, the chunk X11 is accessed for reading the data D (read process S30; (a) normal read (FIG. 13, FIG. 24A)).

At time t1, a node failure occurs in the storage server 110 (#1) to be read of the storage system 100B, and the storage server 110 (#1) becomes unreadable. The failover process S60 of shifting the ownership of the virtual volume 112v from the storage server 110 (#1) to the storage server 110 (#2) is executed ((b0) failover (FIG. 13, FIG. 24A)).

After the failover, the chunks X12 and X13 are accessed for reading the data D ((b) read after failover (FIG. 13, FIG. 24A)).

When the failover process S60 is finished, the rebuild process S70 of restoring the redundant configuration is executed ((c) rebuild (FIG. 13, FIG. 24A)). That is, the data is restored and copied from the chunk X12 of the storage server 110 (#2) and the chunk X13 of the storage server 110 (#3) to the spare chunk S of the storage server 110 (#3), and the data is set as the chunk X11. Similarly, the data is restored and copied from the chunk X22 of the storage server 110 (#3) and the chunk X23 of the storage server 110 (#4) to the spare chunk S of the storage server 110 (#2), and the data is set as the chunk X21. Similarly, the data is restored and copied from the chunk X32 of the storage server 110 (#2) and the chunk X33 of the storage server 110 (#4) to the spare chunk S of the storage server 110 (#3), and the data is set as the chunk X31.

That is, the user data and the redundant data included in the chunks are used to rebuild the user data, and the user data is stored in the storage device of the storage server. The nodes that store the rebuilt user data are nodes different from the nodes storing the other user data and the redundant data in the chunks, and the user data is distributed to a plurality of nodes.

At time t2, the relocation process S80 of integrating the chunks X11, X21, and X31 into the storage server 110 (#1) is executed ((d) relocation (FIG. 13, FIG. 24A)). That is, the chunk X11 of the storage server 110 (#4) is copied to the spare chunk S of the storage server 110 (#1) recovered from the node failure, and the spare chunk S is set as the chunk X11. Similarly, the chunk X21 of the storage server 110 (#2) is copied to the spare chunk S of the storage server 110 (#1) recovered from the node failure, and the spare chunk S is set as the chunk X21. Similarly, the chunk X31 of the storage server 110 (#3) is copied to the spare chunk S of the storage server 110 (#1) recovered from the node failure, and the spare chunk S is set as the chunk X31. After the data is copied to the spare chunks S, the chunk X11 of the storage server 110 (#4), the chunk X21 of the storage server 110 (#2), and the chunk X31 of the storage server 110 (#3) are set as the spare chunks S of the respective storage servers 110.

When the relocation is finished, the failback process S90 of returning the ownership to the recovered storage server 110 (#1) is executed ((e) failback (FIG. 13, FIG. 24B). That is, the virtual volume 112v is moved from the storage server 110 (#2) to the storage server 110 (#1).

After time t3, the chunk X11 is accessed for reading the data D as in (a) normal read ((f) read after failback (FIG. 13, FIG. 24(A)).

### Effect of Second Embodiment

According to the second embodiment, the performance of the distributed rebuild system and the performance of the read local system can also be balanced in the storage system in which the redundant codes based on the erasure coding in one or a plurality of different data protection levels and the mirror data based on the mirroring of data are mixed.

### Third Embodiment

### Configuration of Storage System 100C According to Third Embodiment

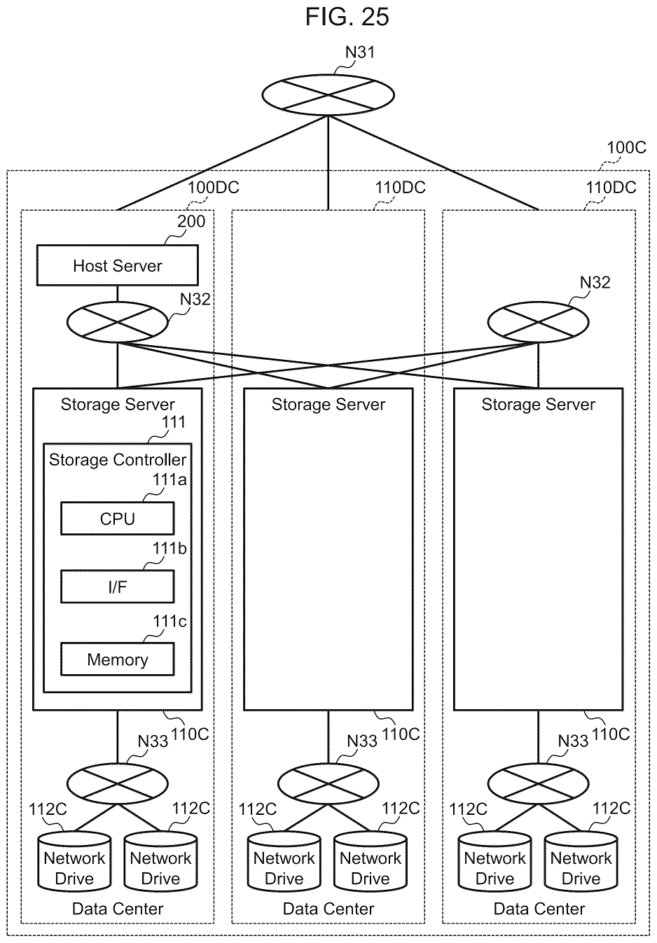

FIG. 25 depicts a configuration of a storage system 100C according to a third embodiment. In the first and second embodiments, the storage system 100 is constructed by on-premises storage servers 110. In contrast, the storage system 100C according to the third embodiment is constructed by cloud storage servers 110C.

The storage system 100C includes a plurality of data centers 100DC connected through a data center connection network N31. In the data center 100DC, the host server 200 and the storage server 110C are connected through a network N32. In the data center 100DC, the storage server 110C and network drives 112C are connected through a network N33. In the third embodiment, the redundant data is arranged across a plurality of data centers 100DC based on the configuration.

Although the data is made redundant between the storage servers 110 in the present embodiment, the data may be made redundant between sites. In this case, the user data is stored in a plurality of storage servers 110 in the same site instead of one storage server 110, and the redundant data is distributed and stored in a larger number of storage servers 110.

Although some embodiments have been described, the embodiments are illustrated to describe the present invention, and the embodiments are not intended to limit the scope of the present invention. The present invention can also be carried out in various other modes, such as a mode in which some of the configurations of the embodiments are deleted, a mode in which at least some of the configurations are replaced, a mode in which another configuration is added, and a mode in which some or all of the embodiments are combined.

What is claimed is:

1. A storage system comprising:
a plurality of nodes each including a storage device that physically stores data and a storage controller, wherein
the storage controller in an active state uses a storage area of the storage device to form a virtual volume, provides the virtual volume to a host, and processes data input and output to and from the storage device through the virtual volume that the storage controller is responsible for,
the storage controller in the active state and the storage controller in a standby state that takes over a process of the storage controller in the active state through failover, the storage controllers being arranged in different nodes, form a redundancy group,
user data input and output by the storage controller in the active state is stored in the storage device of the same node,
redundant data of the user data is stored in the storage device of the node different from the user data, and the storage controller in the standby state changes to the active state and uses the redundant data to input and output data when the failover is performed, and
the redundant data regarding the redundancy group is distributed and stored in a plurality of the nodes.

2. The storage system according to claim 1, wherein
the storage controller changes from the standby state to the active state and inputs and outputs data when the failover is performed, and
the storage controller outputs the data by using the redundant data read from the plurality of nodes including the node provided with the storage controller changed to the active state and other nodes.

3. The storage system according to claim 2, wherein
the storage controller uses the redundant data to perform rebuild of the data and stores the data in the storage device of the node, and
the node that stores the data subjected to the rebuild based on the redundant data distributed and stored in the plurality of nodes is a node different from the nodes storing the corresponding redundant data.

4. The storage system according to claim 3, wherein
the node that stores the rebuilt data is a node storing other redundant data different from the corresponding redundant data.

5. The storage system according to claim 3, wherein,
in failback,
data distributed and stored in a plurality of nodes after performing the rebuild is copied to the node including the storage controller in the active state before the failover, and
the storage controller in the active state of the node uses the data copied to the node to input and output data.

6. The storage system according to claim 1, wherein
a mirror system is used for redundancy,
one piece of the redundant data corresponds to one piece of the user data, and
a plurality of pieces of the redundant data corresponding to a plurality of pieces of the user data stored in one node are distributed and stored in a plurality of the nodes.

7. The storage system according to claim 6, wherein
the storage controller uses the redundant data to perform rebuild of the data and stores the data in the storage device of the node,
the node that stores the data subjected to the rebuild based on the redundant data distributed and stored in the plurality of nodes is a node different from the nodes storing the corresponding redundant data, and
the rebuild is copying of the data.

8. The storage system according to claim 1, wherein
an erasure coding system is used for redundancy,
the redundant data is created based on a plurality of pieces of user data regarding different redundancy groups and stored in different nodes, and is stored in a node not storing any of the plurality of pieces of user data,
the redundant data and the plurality of pieces of the user data from which the redundant data is created are used to form chunks, and
other user data and the redundant data included in the chunks regarding the user data in one redundancy group are distributed and stored in a larger number of nodes than the number of pieces of data.

9. The storage system according to claim 8, wherein
the storage controller uses the user data and the redundant data included in the chunks to perform rebuild of the user data and stores the user data in the storage device of the node, and
the nodes that store the rebuilt user data are nodes different from the nodes storing the other user data and the redundant data in the chunks, and the user data is distributed to a plurality of the nodes.

10. A storage system comprising:
a plurality of nodes each including a storage device that physically stores data and a storage controller, wherein the storage controller in an active state uses a storage area of the storage device to form a virtual volume, provides the virtual volume to a host, and processes data input and output to and from the storage device through the virtual volume that the storage controller is responsible for,
the storage controller in the active state and the storage controller in a standby state that takes over a process of the storage controller in the active state through failover, the storage controllers being arranged in different nodes, form a redundancy group,
user data input and output by the storage controller in the active state is stored in the storage device of the node,
redundant data of the user data is stored in the storage device of the node different from the user data, and the storage controller in the standby state changes to the active state and uses the redundant data to input and output data when the failover is performed,
the user data is stored in one or a plurality of the nodes, and
the redundant data regarding the redundancy group is distributed and stored in a larger number of nodes than the user data.

11. A control method of a storage system executed by the storage system including a plurality of nodes each including a storage device that physically stores data and a storage controller, the method comprising:
by the storage system,
using the storage controller in an active state to form a virtual volume by using a storage area of the storage device, provide the virtual volume to a host, and process data input and output to and from the storage device through the virtual volume that the storage controller is responsible for;
using the storage controller in the active state and the storage controller in a standby state that takes over a process of the storage controller in the active state through failover, the storage controllers being arranged in different nodes, to form a redundancy group;
storing, in the storage device of the same node, user data input and output by the storage controller in the active state; and
storing redundant data of the user data in the storage device of the node different from the user data, and when the failover is performed, changing the storage controller from the standby state to the active state and using the storage controller to input and output data with use of the redundant data, wherein
the redundant data regarding the redundancy group is distributed and stored in a plurality of nodes.
